(19) United States
(12) Patent Application Publication
(10) Pub. No.: US 2012/0171449 A1
(43) Pub. Date: Jul. 5, 2012

(54) ANTI-FLAME FILM AND METHOD FOR PRODUCING THE SAME

(75) Inventors: Jiang-Jen LIN, Taichung (TW); Ya-Chi WANG, Taichung (TW); Yi-Lin LIAO, Taichung (TW); Chih-Wei CHIU, Taichung (TW)

(73) Assignee: NATIONAL CHUNG-HSING UNIVERSITY, Taichung (TW)

(21) Appl. No.: 13/311,429

(22) Filed: Dec. 5, 2011

(30) Foreign Application Priority Data
Dec. 31, 2010 (TW) 099147360

(51) Int. Cl. B32B 19/00; B29D 7/01; B32B 19/02

(52) U.S. Cl. 428/220; 264/212

(57) ABSTRACT

To produce an anti-flame film, nanoscale silicate platelets (NSP) are first diluted with water or an organic solvent; the dispersion is then dried on a surface to remove the water or organic solvent and finally an almost inorganic and flexible film with a thickness of 1 to 1,000 μm is obtained. The film has a regularly layered alignment of primary platelet (1 nm thickness) structure. The NSP film has excellent anti-flame and heat insulation properties that can effectively shield a flame of more than 800° C. without apparent deformation in shape. The NSP can be blended with polymers with a composition over 30% or preferably 70% of NSP to make composite films with significant improvement in flame and heat shielding.

### BACKGROUND OF THE INVENTION

1. Field of the Invention

The present invention relates to the preparation and the anti-flame application of an inorganic film from self-assembly of nanoscale silicate platelets (NSP) into regularly aligned and ordered structure by facile water-evaporation process. The film, consisting of aluminosilicates and other metal oxides for over 94%, with the thickness from 1 to 1,000 μm, is semi-transparent and flexible, and can be applied to fabrics, electronic devices, construction materials, paintings, appliances, and vehicles parts, to provide the property of anti-flame or thermal insulation. The NSP film is optionally blended with organic polymers from 0-70% for improving flexibility.

2. Related Technologies

Aluminosilicate clay is known to have the properties of gas barrier, heat blocking, flame retardancy, and fire resistance. Pure clay film is well known to possess anti-flame and heat insulation properties. However, the preparation and application of the inorganic films have represented a problem due to their lack of flexibility.

A polymer can be incorporated to solve the above issue. References disclosing the related technologies are as follows: (1) G. Johnsy et al., “Aminoclay: A Designer Filler For the Synthesis of Highly Ductile Polymer-Nanocomposite Film” Applied Materials & Interfaces, 1 (2009), 12, 2796-2803; (2) Siska Hamdani et al., “Flame Retardancy of Silicone-Based Materials”, Polymer Degradation and Stability, 94 (2009), 465-495; (3) Hyun-Jeong Nam et al., “Formability And Properties of Self-Standing Clay Film by Montmorillonite With Different Interlayer Cations”, Colloids and Surfaces A: Physicochem. Eng. Aspects, 346 (2009), 158-163; (4) Andreas Walther, et al., “Large-Area, Lightweight and Thick Biomimetic Composites With Superior Material Properties Via Fast, Economic, And Green Pathways”, Nano Lett., 10 (2010), 8, 2742-2748.

However, the anti-flame and heat insulation effects of these organic/inorganic composite films are usually unsatisfactory due to the presence of organic content. In addition, as reported by Hyun-Jeong Nam, Takeo Ebina, Fujio Mizukami, Colloids and Surfaces A: Physicochem. Eng. Aspects, 346 (2009), 158-163, the film formability declined significantly with over 50 wt % of inorganic content.

To overcome the above drawbacks, the present invention provides a film comprised solely of NSP. The NSP film has the flexibility of an organic film, while still retaining the anti-flame and heat insulation properties of an inorganic film.

### SUMMARY OF THE INVENTION

The main objective of the present invention is to provide a method for preparing a flexible film that is mainly inorganic in composition and has anti-flame and thermal insulation properties either with or without polymer incorporation.

In the present invention, the method for producing the anti-flame film primarily includes the steps: (1) preparing a nanoscale silicate platelets (NSP) dispersion by dispersing the NSP in water or an organic solvent, wherein the NSP are prepared from exfoliation of an inorganic clay; and (2) drying the diluted dispersion on a substrate or a container at a temperature in the range of 25 to 80° C. for the water or solvent to evaporate to allow the NSP to self-assemble into regularly aligned stack-layer structure and yield a semi-transparent NSP film with a thickness of 1 μm to 1,000 μm and a flexibility or minimum bend diameter of 1 mm to 100 mm. The thickness of the NSP film is preferably about 2 μm to 500 μm, and more preferably about 5 μm to 100 μm. The minimum bend diameter or flexibility of the NSP film is preferably 1.5 mm to 50 mm, and more preferably 2 mm to 10 mm.

The NSP dispersion is preferably diluted with the water or organic solvent at 5 to 99° C.

The diluted dispersion is preferably dried at 30 to 70° C. in step (2). The films of different thicknesses can be achieved from the dispersions of different concentrations or by different processes, for example, drying in a PET or Teflon pan or spin-coating, spraying or dip-coating on a substrate. When the film is made thinner, its flexibility can be increased.

The NSP includes over 95 wt % inorganic composition (or less than 6% carbon). For example, the NSP comprises metal oxides in the following weight percentages as revealed by energy dispersive spectrometer (EDS) analysis: Na (1-4 wt %), Mg (1-4 wt %), Al (4-17 wt %), Si (10-40 wt %), Fe (1-4 wt %), O (40-80 wt %) and some others in negligible amount or beyond the limit of detection.

In addition, a polymer can be blended with the NSP dispersion in step (1) to afford a nanocomposite film. The NSP/polymer nanocomposite films are prepared at different weight ratios of NSP to the polymer, preferably at 60/40, more preferably at 70/30, and most preferably at 90/10. The polymer can be polyvinyl alcohol (PVA), ethylvinyl alcohol (EVOH), polyvinylpyrrolidone (PVP), polyester, polyethylene terephthalate (PET), polybutylene terephthalate (PBT), polyimide (PI), poly(methylmethacrylate) (PMMA), polystyrene (PS), polyacetal, polyacrylic resin, polyamide, polycarbonate, polyethylene, polypropylene, polybutadiene, polyolefins, polyphenylene sulfide, polyphenylene oxide, polyurethane resin, alkyd resin, epoxy, unsaturated polyester resin, polyurethane, or polyurea; preferably PVA, EVOH, PMMA, PET, polyimide or polystyrene; and more preferably PVA and EVOH.

The anti-flame film of the present invention is superior to the conventional clay or inorganic film in the following properties:

1. excellent flexibility and film formability;
2. excellent anti-flame and heat insulation properties.
3. good dimensional stability at high temperature.

### BRIEF DESCRIPTION OF THE DRAWINGS

FIG. 1 Thermal gravity analysis (TGA) of NSP and MMT.

FIG. 2 Preparation procedure for the NSP film of the present invention.

FIG. 3 Structures of MMT and NSP in aqueous dispersion and their films.

FIG. 4 SEM images on the cross section of (a) MMT film and (b) NSP film.

FIG. 5 Possible mechanism on the anti-flame and heat insulation behaviors of the NSP film.

FIG. 6 SEM images on the cross sections of (a) MMT film and (b) NSP film before the anti-flame test; (c) MMT film and (d) NSP film after the anti-flame tests.

FIG. 7 Temperature profiles of the MMT film and the NSP film during the anti-flame tests.

FIG. 8 Temperature profiles of the environment shielded by the MMT film and the NSP film during the anti-flame tests.

### DETAILED DESCRIPTION OF THE PREFERRED EMBODIMENTS

The materials used in the Examples and Comparative Examples include:
(1) Nanoscale Silicate Platelets (NSP): Prepared from the exfoliation of natural sodium montmorillonite (Na⁺-MMT), each platelet has an aspect ratio of 80×80×1 to 100×100×1 nm³ and specific area about 700 to 800 m²/g. It carries 18,000 to 20,000 charges with a cationic exchanging capacity (CEC) of about 120 mequiv/100 g. X-ray diffraction (XRD) analysis of NSP shows no diffractive peak or featureless in Bragg's pattern. Atomic force microscope (AFM) and transmission electron microscope (TEM) images indicate discrete platelets well dispersed in the polymer matrix. Zeta potentials show that NSP has an isoelectric point at about pH 6.4 in the aqueous solution.
   The preparation of NSP is disclosed in U.S. Pat. Nos. 7,022,299, 7,094,815, 7,125,916, 7,442,728 and 7,495,043. Typically, the procedure involves the followings.

### Step (1): Acidification of the Exfoliating Agent

The exfoliating agent used was an amine-terminated Mannich oligomer sparingly soluble in water. After AMO (57.5 g; 23 meg) was complexed with hydrochloric acid (35 wt % in water, 1.2 g; 11.5 meq), the water-soluble AMO quaternary salt was hence prepared for the MMT exfoliation.

### Step (2): Exfoliation of Sodium Montmorillonite Clay

The acidified AMO (from Step 1) was added into a stirred aqueous dispersion of Na⁺MMT at 80° C. After vigorous agitation for 5 hours, the reaction mixture was allowed to cool to room temperature. The AMO/MMT hybrid was isolated by filtration to remove water. XRD analysis of a sample of the isolated hybrid showed no diffraction peak or featureless in Bragg's pattern.

Step (3): Displacement Reaction of AMO Quaternary Salt with Sodium Ion (I)

An aqueous solution of NaOH (4.6 g in water) was added to the AMO/MMT hybrid (from Step 2) under agitation to afford a thick suspension. After filtration of the suspension, the filtrand was washed with ethanol twice to give AMO/NSP hybrids. TGA analysis indicated an organic composition of 40 wt % due to the presence of AMO.

Step (4): Displacement Reaction of AMO Quaternary Salt with Sodium Ion (II)

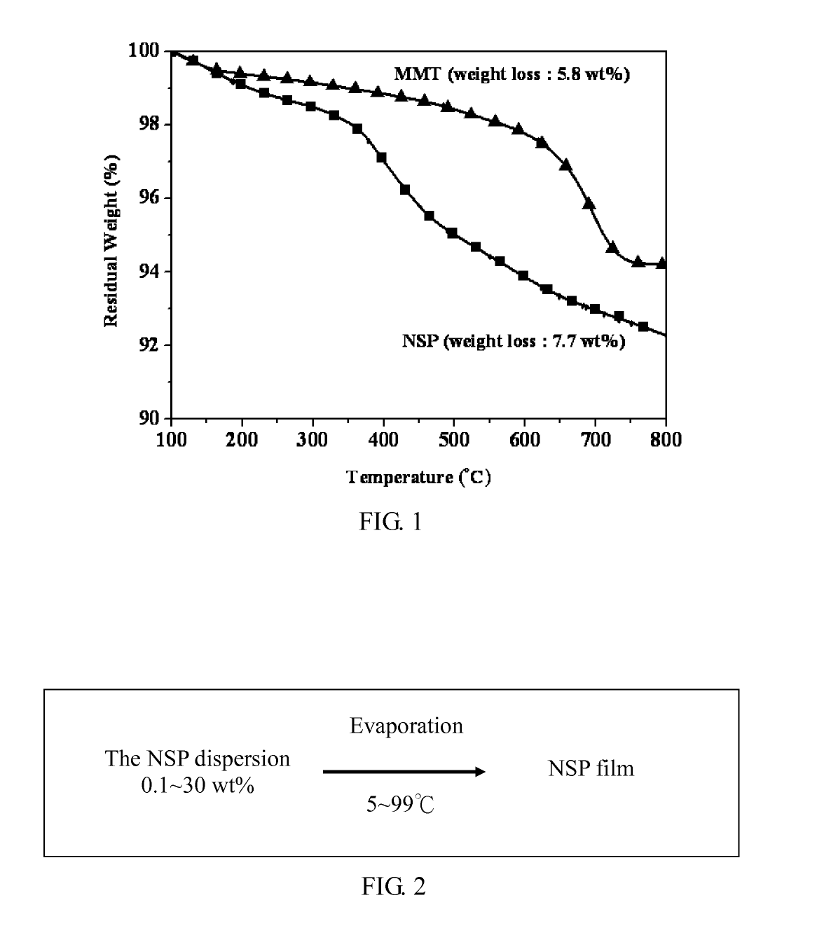

A second displacement reaction was carried out to thoroughly remove AMO. In this step, the isolated AMO/NSP hybrid was mixed vigorously with another portion of NaOH (9.2 g) in ethanol (1 L), water (1 L), and toluene (1 L). After left standing overnight, the mixtures were separated into an upper toluene phase containing the AMO exfoliating agent, a middle phase of clear ethanol, and a lower water phase containing NSP. A comparison between the thermal gravity analysis (TGA) of NSP and MMT indicates less than 2% (7.7−5.8=1.9) of organic impurities in NSP (FIG. 1). Energy-dispersive x-ray spectroscopy (EDS) further evidences the low organic contamination in NSP by showing less than 1.5 (5.02−3.52=1.50) wt % of carbon from AMO (TABLE 1). The AMO oligomers in toluene phase can be easily recycled by solvent evaporation.

TABLE 1

| | | Element | | | | | | |
|---|---|---|---|---|---|---|---|---|
| | | C | O | Na | Mg | Al | Si | Fe |
| Weight | MMT film | 3.52 | 51.3 | 3.23 | 1.92 | 10.7 | 27.9 | 1.33 |
| (%) | NSP film | 5.02 | 58.6 | 2.19 | 1.99 | 8.96 | 22.6 | 1.78 |

(2) Montmorillonite: Na⁺-MMT, cationic exchanging capacity (CEC)=120 mequiv/100 g, product of Nanocor Co., product name “PGW”.
(3) polyvinyl alcohol (PVA), ethylvinyl alcohol (EVOH), polyvinyl pyrrolidone (PVP).

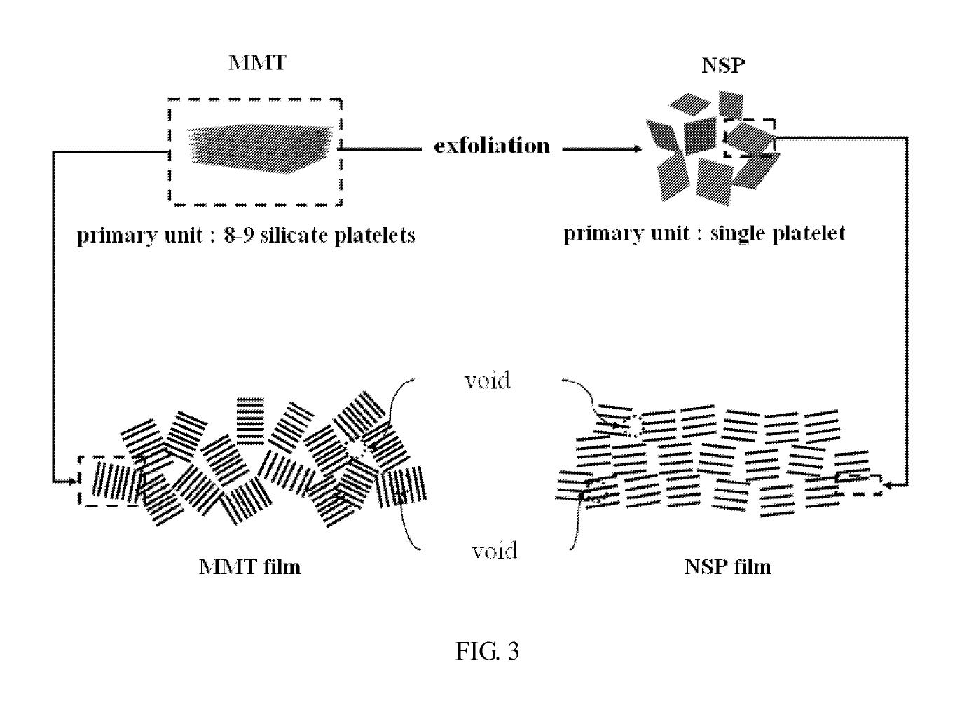

The films of the present invention are prepared as follows (FIG. 2) under the processing conditions shown in TABLE 2.

TABLE 2

| | | | Temperature | Time for | |
|---|---|---|---|---|---|
| | NSP in the | | for film | film | Thickness |
| | dispersion | NSP/PVA | formation | formation | of the film |
| Example | (wt %) | (w/w) | (° C.) | (hours) | (μm) |
| Example 1 | 3 | 100/0 | Room temp. | 24 | 5 |
| Example 2 | 3 | 100/0 | Room temp. | 24 | 5 |
| Example 3 | 5 | 100/0 | Room temp. | 24 | 5 |
| Example 4 | 5 | 100/0 | Room temp. | 24 | 5 |
| Example 5 | 5 | 100/0 | 30 | 5 | 5 |
| Example 6 | 5 | 100/0 | 50 | 3 | 5 |
| Example 7 | 5 | 100/0 | 60 | 3 | 50 |
| Example 8 | 3.5 | 70/30 | 60 | 3 | 50 |
| Example 9 | 2.5 | 50/50 | 60 | 3 | 50 |
| Example | 1.5 | 30/70 | 60 | 3 | 50 |
| 10 | | | | | |
| Compar- | 5 | 0/100 | 60 | 3 | 50 |
| ative | | | | | |
| Example 1 | | | | | |
| Compar- | MMT 5 | MMT/ | 60 | 3 | 50 |
| ative | | PVA | | | |
| Example 2 | | 100/0 | | | |

### Example 1

A NSP dispersion (50 g, 10 wt %) was added into a beaker and diluted with de-ionized water (110 g) with mechanically stirring for one hour at room temperature. The NSP dispersion was casted onto a PET pan and dried on a hotplate at 60° C. overnight to remove water to afford a free-standing NSP film with 20 μm thickness. The film was analyzed by EDS and TGA as shown the data in Table 1 and FIG. 1.

### Example 2

A NSP dispersion (100 g, 10 wt %) was added into a beaker and diluted with de-ionized water (233 g) with mechanically stirring for three hours at room temperature. The NSP dispersion was casted onto a PET pan and dried at room temperature overnight to remove water to afford a free-standing NSP film with 40 μm thickness.

### Example 3

A NSP dispersion (50 g, 10 wt %) was added into a beaker and diluted with de-ionized water (50 g) with mechanically stirring for two hours at room temperature. The NSP dispersion was casted onto a Teflon pan and dried at room temperature overnight to remove water to afford a free-standing NSP film with 20 μm thickness.

### Example 4

A NSP dispersion (100 g, 10 wt %) was added into a beaker and diluted with de-ionized water (100 g) with mechanically stirring for three hours at room temperature. The NSP dispersion was processed by spinning coating at room temperature for film formation. After dried overnight at room temperature overnight, a NSP film with 5 μm thickness was obtained.

### Example 5

A NSP dispersion (50 g, 10 wt %) was added into a beaker and diluted with de-ionized water (50 g) with mechanically stirring for two hours at room temperature. The NSP dispersion was processed by spinning coating at 30° C. for film formation. After dried for 5 hours at room temperature, a NSP film with 5 μm thickness was obtained.

### Example 6

A NSP dispersion (50 g, 10 wt %) was added into a beaker and diluted with de-ionized water (50 g) with mechanically stirring for two hours at room temperature. The NSP dispersion was processed by spraying at 50° C. for film formation. After dried for 3 hours at room temperature, a NSP film with 5 μm thickness was obtained.

### Example 7

A NSP dispersion (50 g, 10 wt %) was added into a beaker and diluted with de-ionized water (50 g) with mechanically stirring for two hours at room temperature. The NSP dispersion was processed by dip-coating at 60° C. for film formation. After dried for 3 hours at room temperature, a NSP film with 10 μm thickness was obtained.

### Example 8

A NSP dispersion (35 g, 10 wt %), a PVA aqueous solution (15 g, 10 wt %), and de-ionized water (50 g) were added into a beaker with mechanically stirring for two hours at room temperature. The mixture was then processed by dip-coating for film formation at 60° C. After dried for 3 hours at room temperature, a NSP/PVA composite film (NSP/PVP=70/30) with 6 μm thickness was obtained.

### Example 9

A NSP dispersion (25 g, 10 wt %), a PVA aqueous solution (25 g, 10 wt %), and de-ionized water (50 g) were added into a beaker with mechanically stirring for two hours at room temperature. The mixture was then processed by dip-coating for film formation at 60° C. After dried for 3 hours at room temperature, a NSP/PVA composite film (NSP/PVP=50/50) with 5 μm thickness was obtained.

### Example 10

A NSP dispersion (15 g, 10 wt %), a PVA aqueous solution (35 g, 10 wt %), and de-ionized water (50 g) were added into a beaker with mechanically stirring for two hours at room temperature. The mixture was then processed by dip-coating for film formation at 60° C. After dried for 3 hours at room temperature, a NSP/PVA composite film (NSP/PVP=30/70) with 5 μm thickness was obtained.

### Comparative Example 1

### MMT Film

A MMT aqueous solution (100 g, 5 wt %) was processed by dip-coating for film formation at 60° C. After dried for 3 hours at room temperature, a MMT film with 11 μm thickness was obtained. The film was analyzed and compared as shown in Table 1 and FIG. 1.

### Comparative Example 2

### PVA Polymer Film

A PVA aqueous solution (100 g, 5 wt %) was processed by dip-coating for film formation at 60° C. After dried for 3 hours at room temperature, a PVA film with 10 μm thickness was obtained.

The NSP film (Example 1) is free-standing, semi-transparent, and flexible. In the present invention, flexibility is expressed in term of minimum bend diameter measured by rolling the film over a cylinder of a defined diameter without causing film fracture. The film has a minimum bend diameter of about 2 mm.

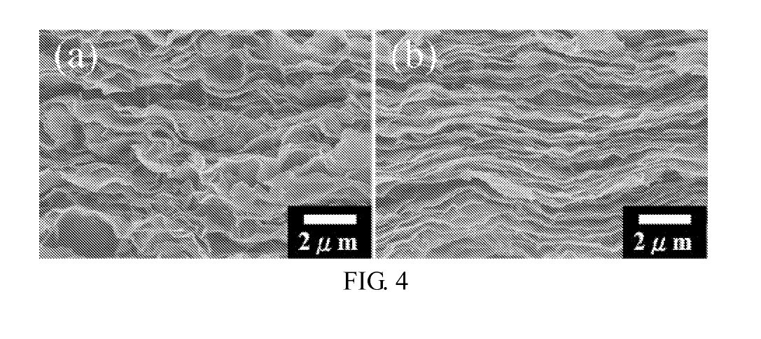

FIG. 3 shows structures of MMT and NSP in aqueous dispersion and their films. FIG. 4 shows the SEM images on the cross section of (a) MMT film (Comparative Example 1) and (b) NSP film (Example 7). The NSP film has a more compacted and regularly-aligned structure than the film from the pristine MMT.

### Anti-Flame and Anti-Heat Test

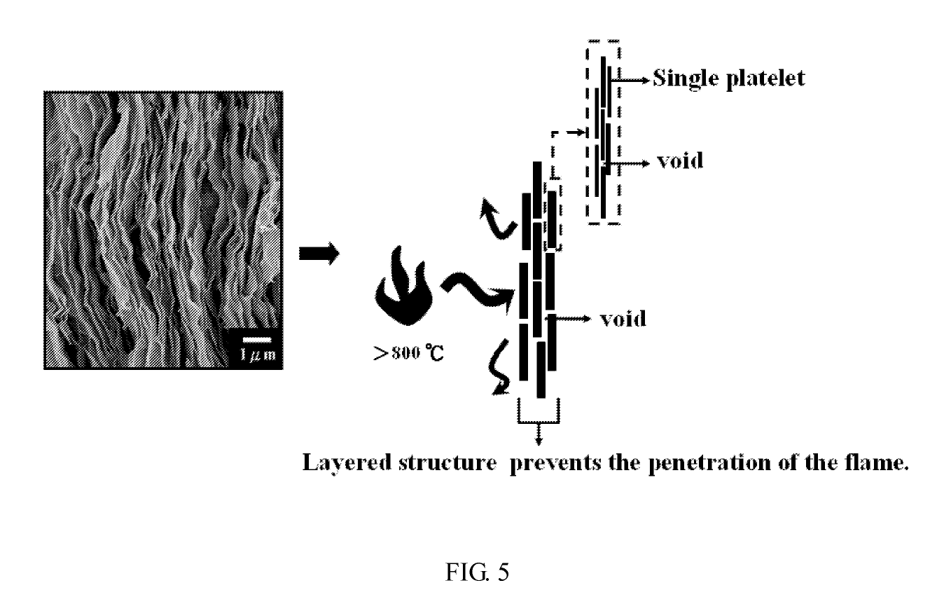

FIG. 5 illustrates the possible mechanism on the anti-flame and heat insulation behaviors of the NSP film. The regular layered-structures and large percentage of voids of the NSP film provide an effective shielding that can prevent flame and heat propagation along x, y and z directions. The lower-left figure is the NSP film after continuously exposed to a flame for 1 hour. The limited size of the dark-colored center clearly shows that heat propagation does not occur along x and y directions.

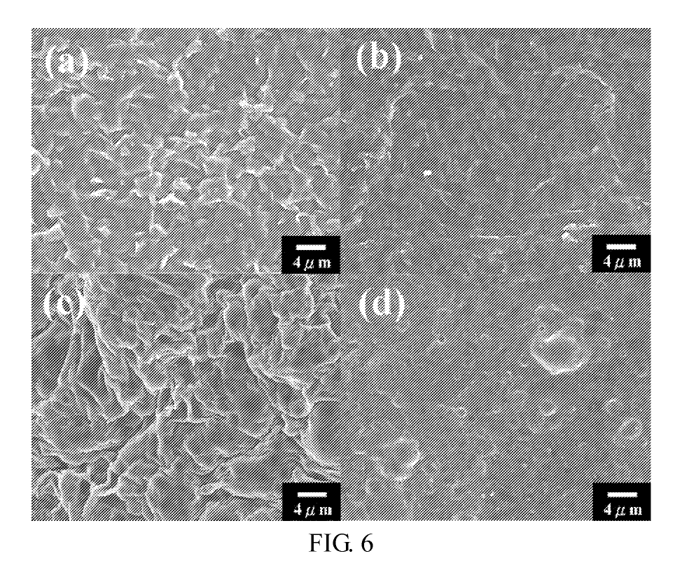

FIG. 6 are the SEM images on the cross sections of (a) MMT film and (b) NSP film before the anti-flame test; and (c) MMT film and (d) NSP film after the anti-flame tests. A comparison between FIGS. 6(a) and 6(b) demonstrates that MMT film has a rougher surface structure than the NSP film. In FIGS. 6(c) and 6(d), the surface of the NSP film is only slightly uneven and almost identical to the image of (b). On the other hand, the surface of the MMT film is obviously corrugated along with the formation of small holes due to non-uniform thermal expansion in different parts of the film. Evidently, NSP film has a regular and compacted layered structure that affords the film excellent dimensional stability at high temperature.

### Temperature Profiles of the Films and the Shielded Environment

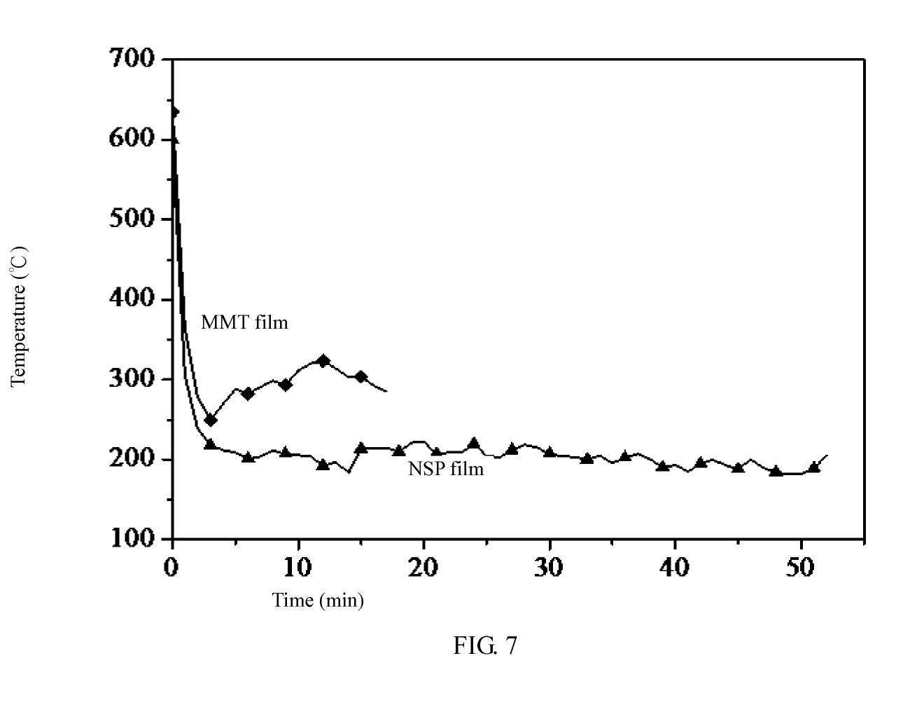

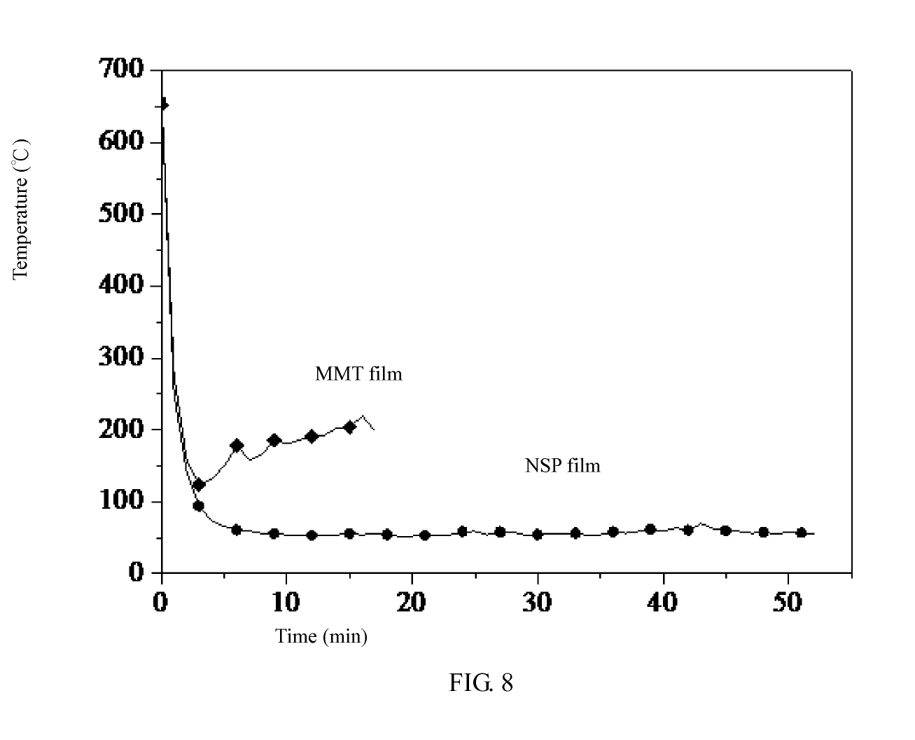

FIG. 7 and FIG. 8 show the temperature profiles of the films and the shielded environment during the anti-flame tests, respectively. Two thermocouples, one in direct contact with the film facing flame (T1) and the other one 1 cm away from the side shielded by the film (T2), are set up to detect the temperature variation. FIG. 7 demonstrates the plot of temperature readings at T1 verse test time. Within 5 minutes, the temperature of the NSP film is lowered to 200° C. MMT film, however, is penetrated by flame, and thus the test was terminated. In FIG. 8, the temperature at T2 is lowered to 55° C. in the case of NSP film. This clearly indicates the excellent anti-flame and heat insulation capabilities of the NSP film.

### Tests for the MMT Film

A similar test is performed by shielding a cotton ball with a clay film, rather than by detecting the temperature with a thermocouple. The films are 20 μm in thickness. After being burned for 1 minute, the MMT film is punctured by flame which ultimately contacts and burns the cotton ball. The cotton ball shielded by the NSP film only darkens in color on the side facing the film.

### Tests for the NSP/PVA Film

The NSP/PVA composite films of different weight ratios are tested for the anti-flame tests. The films all have an area of 3×3 cm² and 50 μm in thickness. Pure PVA film immediately burns upon contacting the flame. The NSP/PVA composite film (w/w=30/70) burns for a very short moment, but the fire diminishes almost immediately. The film deforms in shape but shows no dripping. With increasing the inorganic NSP content, the composite films (w/w=50/50 and 70/30) have better dimension stability at high temperature. The pure NSP film is unaffected by flame treatment. An indication of low heat propagation is demonstrated by the white-colored area that does not contact with the flame.

According to the above descriptions and results, the present invention provides a simple method to prepare a flexible inorganic film with good anti-flame effect from the regular alignment of the silicate platelets. With the ordered structure, the film is able to withstand a temperature as high as 800° C. for at least 70 min. The film can be blended with polymers during manufacturing or combined with a polymeric film or metal sheet to afford a composite film.

In the present invention, the solvent, processing temperature, or drying methods is not limited. For example, the solvent can be removed by evaporation at room temperature or in an oven at moderate temperature. Any suitable container or pan can be used to accommodate the dispersion, and the required time can be adjusted with the temperature accordingly. Wet coating methods include spin coating, doctor blade coating, dip coating, roll coating, spray coating, powder coating, slot die coating, slide coating, curtain coating, or nanoimprint/nanoprint.

In the present invention, the formed film can be blended with a polymer to form flexible composite material. The polymers include, but not limited to, polyvinyl alcohol (PVA), ethylvinyl alcohol (EVOH), polyvinylpyrrolidone (PVP), polyester, polyethyleneterephthalate (PET), polybutylene terephthalate polyimide (PI), polymethylmethacrylate (PMMA), polystyrene (PS), polyacetal, polyacrylic resin, polyamide, polycarbonate resin, polyolefins, polyphenylene sulfide, polyphenylene oxide resin, polyurethane-based resin, alkyd resin, epoxy, unsaturated polyester resin, and polyurea.

The NSP aqueous dispersion used in the present invention can be manufactured on an industrial scale. This allows the mass production of NSP films, which can be widely applied to fire-proof paintings, electronic devices, construction materials, and etc.

We claim:

1. A method for producing an anti-flame film, comprising steps of:
(1) preparing a nanoscale silicate platelets (NSP) dispersion by dispersing the NSP in water or an organic solvent, wherein the NSP are prepared from exfoliation of an inorganic clay; and
(2) drying the diluted dispersion on a substrate or a container at a temperature in the range of 25 to 80° C. for the water or solvent to evaporate to allow the NSP to self-assemble into regularly aligned stack-layer structure and yield a semi-transparent NSP film with a thickness of 1 μm to 1,000 μm and a flexibility or minimum bend diameter of 1 mm to 100 mm.

2. The method of claim 1, wherein the NSP comprises metal oxides in the following weight percentages as revealed by EDS analysis: Na (1-4 wt %), Mg (1-4 wt %), Al (4-17 wt %), Si (10-40 wt %), Fe (1-4 wt %), O (40-80 wt %) and some others in negligible amount or beyond the limit of detection.

3. The method of claim 1, wherein the inorganic clay is montmorillonite, bentonite, laponite, synthetic mica, kaolinite, talc, attapulgite clay, vermiculite or layered double hydroxides (LDH)

4. The method of claim 1, wherein the solvent is water, dimethyl formamide, methanol, ethanol, iso-propyl alcohol, methyl tert-butyl ether, acetone, methyl ethyl ketone or methyl isobutyl ketone.

5. The method of claim 1, wherein the NSP dispersion is diluted with water or organic solvents at 5 to 99° C.

6. The method of claim 1, wherein the diluted dispersion is molded at 30 to 70° C.

7. The method of claim 1, wherein in step (1) a polymer is mixed with the NSP dispersion and the solvent, and the weight ratio of the NSP dispersion to the polymer is at least 30/70.

8. The method of claim 7, wherein the polymer is polyvinyl alcohol (PVA), ethylvinyl alcohol (EVOH), polyvinylpyrrolidone (PVP), polyester, polyethyleneterephthalate (PET), polybutylene terephthalate polyimide (PI), polymethylmethacrylate (PMMA), polystyrene (PS), polyacetal, polyacrylic resin, polyamide, polycarbonate resin, polyolefins, polyphenylene sulfide, polyphenylene oxide resin, polyurethane-based resin, alkyd resin, epoxy, unsaturated polyester resin, or polyurea.

9. An anti-flame film, comprising nanoscale silicate platelets (NSP) with over 95 wt % inorganic composition (or carbon less than 6%) and having a thickness of about 1 to 1,000 μm and flexibility with a minimum bend diameter of about 1 to 100 mm; wherein the NSP are fully exfoliated inorganic silicate clay in the form of independently dispersed platelet units and have an isoelectric point at about pH 6.4 in an aqueous solution; and the inorganic silicate clay is selected from the group consisting of montmorillonite, bentonite, laponite, synthetic mica, kaolinite, talc, attapulgite clay, vermiculite and layered double hydroxides (LDH).

10. The anti-flame film of claim 9, further comprising a polymer blended with the NSP, and the weight ratio of the NSP to the polymer is at least 30/70.

11. The anti-flame film of claim 10, wherein the polymer is polyvinyl alcohol (PVA), ethylvinyl alcohol (EVOH), polyvinylpyrrolidone (PVP), polyester, polyethylene terephthalate (PET), polybutylene terephthalate polyimide (PI), poly(methylmethacrylate) (PMMA), polystyrene (PS), polyacetal, polyacrylic resin, polyamide, polycarbonate resin, polyolefins, polyphenylene sulfide, polyphenylene oxide resin, polyurethane-based resin, alkyd resin, epoxy, unsaturated polyester resin, or polyurea.
